(19) United States
(12) Patent Application Publication
(10) Pub. No.: US 2014/0370262 A1
(43) Pub. Date: Dec. 18, 2014

(54) THREE-DIMENSIONAL GRAPHENE STRUCTURE, AND PREPARATION METHOD THEREOF

(71) Applicant: INDUSTRY-ACADEMIC COOPERATION FOUNDATION, YONSEI UNIVERSITY, Seoul (KR)

(72) Inventors: Kwang Bum Kim, Gyeonggi-do (KR); Ho Rim Kang, Ulsan (KR); Sang Hoon Park, Seoul (KR); Hyun Kyung Kim, Chungcheongbuk-do (KR)

(73) Assignee: INDUSTRY-ACADEMIC COOPERATION FOUNDATION YONSEI UNIVERSITY, Seoul (KR)

(21) Appl. No.: 14/371,671

(22) PCT Filed: Jan. 30, 2013
(86) PCT No.: PCT/KR2013/000762

§ 371 Date: Jul. 10, 2014

(30) Foreign Application Priority Data
Jan. 30, 2012 (KR) 10-2012-0009106

(51) Int. Cl. C01B 31/04

(52) U.S. Cl. CPC C01B 31/0446
USPC 428/219; 423/448; 516/98

(57) ABSTRACT

A method of preparing a three-dimensional graphene structure, and a graphene structure prepared by the method are provided. The method includes preparing a dispersion in which a graphite oxide is dispersed, and preparing a gel by controlling a degree of reduction of the dispersion. The method can be useful in providing a three-dimensional graphene structure having a specific surface area, a pore size or a volume per unit mass, which is suitable for the field of applications thereof.

### CROSS-REFERENCE TO RELATED APPLICATION

This application claims priority to and the benefit of Korean Patent Application No. 2012-0009106, filed Jan. 30, 2012, the disclosure of which is incorporated herein by reference in its entirety.

### BACKGROUND

1. Field of the Invention

The present invention relates to a three-dimensional graphene structure and a method of preparing the same.

2. Discussion of Related Art

Graphene represents a carbon structure with a two-dimensional (2D) nanosheet single layer in which sp² carbon atoms are used to form a hexagonal honeycomb lattice. In general, graphene is a compound which has come into the spotlight as a new material having excellent physical and chemical stability, a high specific surface area and excellent electric conductivity. Graphene having such physical properties can function as an efficient template on which a nano-sized metal oxide can be deposited. Also, graphene has unlimited applicability to energy storage materials (lithium ion secondary batteries, hydrogen storage fuel cells, and electrodes for supercapacitors), gas sensors, mirco-parts for biomedical engineering, highly functional complexes, and the like through formation of nanocomplexes with transition metals.

However, graphene has a problem in that it is not easily peeled off in a solution due to the presence of van der Waals interaction between basal planes of graphene caused by a sp² carbon bond formed on a surface of graphene. As a result, graphene is mainly present in the form of multilayer graphene other than single-layer graphene, and has a restacking property to be restacked even when graphene is peeled off. Therefore, the condensed or restacked graphene has reduced specific surface area and electric conductivity.

### SUMMARY OF THE INVENTION

### 1. Technical Problem

The present invention is directed to providing a method preparing a three-dimensional graphene structure having desired physical properties by controlling pH of a graphite oxide dispersion used in a preparation process, and a graphene structure prepared by the method.

### 2. Technical Solution

One aspect of the present invention provides a method preparing a three-dimensional graphene structure, which includes preparing a dispersion in which a graphite oxide is dispersed, and controlling a degree of reduction of the dispersion to preparing a gel.

Another aspect of the present invention provides a three-dimensional graphene structure including pores having an average diameter of 40 to 150 Å. Here, the three-dimensional graphene structure has a specific surface area of 300 to 800 m²/g.

### 3. Effect of the Invention

The method of preparing graphene according to the present invention can be useful in preventing condensation to restacking of graphene, and providing a three-dimensional graphene structure having a specific surface area, a pore size and a volume per unit mass, which are suitable for the field of applications thereof.

### BRIEF DESCRIPTION OF THE DRAWINGS

FIG. 1 is an image obtained by observing graphene structures prepared in Examples 1 and 4.

FIG. 2 is a scanning electron microscope (SEM) image of a graphene structure according to one exemplary embodiment of the present invention.

FIG. 3 is a graph illustrating a change in specific surface area of a graphene structure prepared according to the pH of a dispersion.

FIG. 4 is a graph illustrating a change in pore size of the graphene structure prepared according to the pH of the dispersion.

FIG. 5 is a graph illustrating a change in volume per unit mass of the graphene structure prepared according to the pH of the dispersion.

### DESCRIPTION

The present invention is directed to providing a three-dimensional graphene structure, and a method of preparing the same.

By reference, the term “part(s) by weight” used herein may refer to a weight ratio between the respective components.

Also, the term “three-dimensional graphene structure” or “graphene structure” used herein means that graphene has a planar structure, that is, graphene is in a form so that it has a steric structure rather than single layer graphene or multilayer graphene in which layers of graphene are simply stacked in parallel.

Using the preparation method, a graphene structure having desired physical properties may be prepared by properly controlling pH of a solution in which a graphite oxide is dispersed.

According to one exemplary embodiment, the method of preparing a graphene structure includes preparing a dispersion in which a graphite oxide is dispersed, and controlling a degree of reduction of the dispersion to preparing a gel.

The preparing of the dispersion in which the graphite oxide is dispersed includes preparing the dispersion by dispersing powder of the graphite oxide in a solvent. Waster or an organic solvent may be used alone or in combination as the solvent to disperse the graphite oxide powder. A polar or non-polar solvent may be used as the organic solvent, and, for example, may include methanol, ethanol, propanol, pentane, methylpropanone, butanone, trimethylpentane, fluoroalkane, hexane, cyclohexane, cyclopentane, pentene, benzene, toluene, xylene, chloropropane, chlorobenzene, bromoethane, dienyl ether, isopropyl ether, dienyl sulfide, chloroform, tetrahydrofuran, dichloroethane, nitropropane, acetone, dioxane, methyl acetate, ethyl acetate, dimethyl sulfoxide, diethylamine, nitromethane, acetonitrile, pyridine, butoxyethanol, ethylene glycol, acetic acid, or a mixed solvent.

According to one exemplary embodiment, the preparing of the dispersion in which the graphite oxide may include applying ultrasonic waves to the dispersion including the graphite oxide powder. Application of the ultrasonic waves may be performed at the same time while adding the graphite oxide powder to the solvent, and may also be performed after addition of the graphite oxide powder to the solvent. In addition, the preparing of the dispersion in which the graphite oxide does not exclude simple stirring in addition to application of the ultrasonic waves.

A method of preparing a graphite oxide used in the present invention is not particularly limited. For example, the graphite oxide may be prepared using methods usually used in the related art. The graphite oxide may be a powder formulation, and, for example, may be prepared using a Brodie's method, a Staudenmaier's method or a Hummer's method. By way of example, the graphite oxide may be used to prepare powder of the graphite oxide using a modified Hummer's) method.

According to one exemplary embodiment, various physical properties of the graphene structure may be adjusted, using the method according to the present invention, by controlling a pH range in the controlling of the degree of reduction of the dispersion to prepare the gel. For example, at least one of the average specific surface area, average pore size and volume per unit mass of the graphene structure may be adjusted by controlling the pH range.

For example, the average specific surface area of the graphene structure may satisfy the following Equation 1.

[BET]=a₁×P+b₁ [Equation 1]

In Equation 1,

[BET] represents a specific surface area (m²/g) of the resulting graphene structure, and P represents a pH of the dispersion, provided that:

(i) a₁ is an integer ranging from −40 to −25, and b₁ is an integer ranging from 400 to 600 when P is less than or equal to 5, and

(ii) a₁ is an integer ranging from 50 to 100, and b₁ is an integer ranging from −100 to 50 when P is greater than 5.

By way of another example, the average pore size of the graphene structure may satisfy the following Equation 2.

[Pore Size]=a₂×P+b₂ [Equation 2]

In Equation 2,

[Pore Size] represents an average pore size (Å) of the resulting graphene structure, and P represents a pH of the dispersion, provided that:

(i) a₂ is an integer ranging from −15 to −5 and b₂ is an integer ranging from 120 to 140 when P is less than or equal to 5,

(ii) a₂ is an integer ranging from 7 to 18 and b₂ is an integer ranging from 0 to 20 when P is greater than 5 or less than or equal to 6, and

(iii) a₂ is an integer ranging from −20 to −15 and b₂ is an integer ranging from 140 to 180 when P is greater than 6.

By way of still another example, the volume per unit mass of the graphene structure may satisfy the following Equation 3.

[Volume]=a₃×P+b₃ [Equation 3]

In Equation 3,

[Volume] represents a volume per unit mass (mm³/g) of the resulting graphene structure, and P represents a pH of the dispersion, provided that:

(i) a₃ is an integer ranging from 15 to 25 and b₃ is an integer ranging from 0 to 40 when P is less than or equal to 5, and

(ii) a₃ is an integer ranging from −18 to −10 and b₃ is an integer ranging from 170 to 220 when P is greater than or equal to 5.

In the preparing of the dispersion in which the graphite oxide is dispersed, the content of the graphite oxide may be in a range of 1 to 10 parts by weight, or 2 to 6 parts by weight, based on 100 parts by weight of a solvent. In the present invention, the density of the graphene structure maybe adjusted by adjusting the content of the graphite oxide. The content of the graphite oxide is selected within a sufficient content range to prevent energy density per mass from falling dawn due to an excessive decrease in density of the resulting graphene structure, and to enhance a degree of dispersion of the graphite oxide at the same time.

In the controlling of the degree of reduction of the dispersion to prepare the gel according to the present invention, the degree of reduction may be controlled using a method of mixing a reducing agent with the dispersion, a method of subjecting the dispersion to a heat treatment process, or a method of forming other surrounding environments as a reducing atmosphere. In this case, specific methods are not particularly limited. Functional groups, for example, a carboxyl group (—COOH), a formyl group (—CHO) and/or a carbonyl group (—CO—), present on a surface of the graphite oxide are reduced into water (H₂O) by controlling a degree of reduction of the dispersion, which results in removal of the functional groups. During reduction of the graphite oxide, hydration may occur on the surface of the graphite oxide reduced by the functional group, for example, a carboxyl group (—COOH), remaining on the surface of the graphite oxide. When hydrated, sp² bonds between carbon atoms constituting the graphite oxide are restored, and π-π bonds may be formed by restoration of the sp² bonds, which results in formation of a three-dimensional gel having pores.

The kind of reducing agents that may be used herein is not particularly limited. For example, any reducing agents may be used as long as they can reduce functional groups on the surface of the graphite oxide into water. Examples of the reducing agent includes one or more selected from the group consisting of ascorbic acid (C₆H₈O₆), sodium sulfide (Na₂S), hydrogen iodide (HI), and sodium hydrogen sulfite (NaHSO₃). For example, ascorbic acid, which is also referred to as vitamin C, may be used as the reducing agent. The content of the reducing agent is not particularly limited, and, for example, may be in a range of 200 to 2,000 parts by weight, or 300 to 800 parts by weight, based on 100 parts by weight of the graphite oxide. The content of the reducing agent is selected within a sufficient content range to induce sufficient reductions and have no excessive reducing agent.

In the controlling of the degree of reduction of the dispersion to prepare the gel, the pH of the dispersion may be adjusted as acidic, neutral or basic pH.

According to one exemplary embodiment, the pH of the dispersion may be in a range of 1.5 to 5, or 2 to 4. In this controlling operation, the pH range may be adjusted by mixing a pH control agent. The kind of the pH control agent is not particularly limited, and, for example, may include at least one selected from the group consisting of hydrochloride, sulfuric acid, and nitric acid. For example, a hydrochloride solution may be used as the pH control agent. As the pH of the solution in which the graphite oxide is dispersed is lowered, the solution has a smaller pore size and the density of the graphene structure increases. More particularly, as the pH decreases, a repulsion force between graphite oxides is reduced when a three-dimensional hydrogel is formed through reduction of the graphite oxide. As a result, the π-π bonds are easily formed, which results in a decrease in size of the pores.

According to another exemplary embodiment, the pH of the dispersion may be in a range of 8.8 to 13.5, or 9 to 13. In this controlling operation, the pH range may be adjusted by mixing a pH control agent. The kind of the pH control agent is not particularly limited, and, for example, may include at least one selected from the group consisting of sodium hydroxide, potassium hydroxide and ammonium hydroxide. For example, a sodium hydroxide solution may be used as the pH control agent. This is done to adjust the pH of a dispersion solution without affecting a concentration of the graphite oxide to the maximum extent since the concentration of the graphite oxide affects the pore size and density of the three-dimensional graphene structure.

According to still another exemplary embodiment, the pH of the dispersion may be in a range of 5 to 8.8, or 5.5 to 8. In this controlling operation, the pH range may be adjusted closely to a neutral pH by mixing a pH control agent, or adjusted without using a separate pH control agent.

Also, the controlling of the degree of reduction of the dispersion to prepare the gel may include subjecting the gel to a first heat treatment process after controlling the degree of reduction of the dispersion and before preparation of the gel. The first heat treatment process may be performed at a temperature of 60° C. to 90° C. As a heat treatment temperature decreases, a time required to form a gel is extended. When the heat treatment temperature is excessively high, the formed gel structure may be changed. A time required for heat treatment is not particularly limited, and the heat treatment may be, for example, performed for 10 to 60 hours, or 24 to 8 hours.

According to yet another exemplary embodiment, the method according to the present invention may further include performing a second heat treatment process after the first heat treatment process. As the gel is subjected to this second heat treatment process, the gel is formed into aerogel while removing moisture or organic solvent components included in the gel. The second heat treatment process may be performed at a temperature of 70° C. to 95° C. for 2 to 5 hours. A necessary time required for subsequent processes may be curtailed through this second heat treatment process, and the pore size and density of the graphene structure may be adjusted more compactly.

The preparation method according to the present invention may further include drying the gel after controlling the degree of reduction of the dispersion to prepare the gel. For example, the resulting gel is lyophilized to prepare a three-dimensional graphene structure. As previously described above, this operation may include lyophilizing hydrogel or aerogel from which a predetermined amount of moisture or organic solvent components are removed through the second heat treatment process. For example, the hydrogel may be lyophilized at a temperature of −60° C. to −50° C. The hydrogel may be transformed into aerogel by means of lyophilization without a change in pore size and density of the hydrogel. A lyophilization time is not particularly limited, and, may, for example, be in a range of 12 hours to 8 hours, or 24 hours to 36. Lyophilization may be performed under a vacuum or a very low pressure. For example, the lyophilization may be performed at a pressure of 10⁻⁵ Pa to 10⁻¹ Pa.

According to one exemplary embodiment, the preparation method according to the present invention may further include applying microwaves to the gel after lyophilization of the gel. Additional reduction of functional groups remaining on the surface of the graphite oxide may be induced through application of the microwaves, and the electric conductivity of the resulting graphene structure may be improved. For example, the application of the microwaves may be performed under an inert gas atmosphere such argon. A time required to apply the microwaves may be in a range of 10 seconds to 300 seconds, or 30 seconds to 120 seconds. The electric conductivity may be improved through the application of the microwaves while minimizing an effect on the pore size and density of the graphene structure.

Also, the present invention is directed to providing a three-dimensional graphene structure. A method of preparing the graphene structure is as described above.

According to one exemplary embodiment, the graphene structure includes pores having an average size of 40 to 150 Å. The average size of the pores formed in the graphene structure may be in a range of 40 to 150 Å, 70 to 120 Å, 70 to 110 Å, 40 to 60 Å, or 50 to 110 Å.

According to another exemplary embodiment, the graphene structure is a three-dimensional structure having a specific surface area of 300 to 800 m²/g. The specific surface area of the graphene structure may be in a range of 300 to 800 m²/g, 300 to 450 m²/g, 410 to 450 m²/g, 600 to 750 m²/g, or 410 to 750 m²/g.

According to still another exemplary embodiment, the graphene structure may have a volume per unit mass of 50 to 150 mm³/g. The volume per unit mass of the graphene structure may be in a range of 50 to 150 mm³/g, 60 to 130 mm³/g, 85 to 110 mm³/g, 60 to 85 mm³/g, or 65 to 130 mm³/g.

As described above, the three-dimensional graphene structure can have nano-sized pores, a specific surface area and a volume per unit mass to a wide extent, and thus a graphene structure having an excellent energy density per unit mass can be prepared. The graphene structure can be used in electrodes for various devices. The kind of the devices is not particularly limited, but, may, for example, include energy storage devices such as secondary batteries, fuel cells, or capacitors. Also, the graphene structure can be used in gas sensors, mirco-parts for biomedical engineering, or highly functional complexes.

Hereinafter, the present invention will be described in further detail with reference to Examples according to the present invention. It should be understood that the description proposed herein is merely a preferable example for the purpose of illustrations only, not intended to limit the scope of the invention.

### EXAMPLES

### Preparative Example

### Preparation of Graphite Oxide Powder

Powder of a graphite oxide was prepared using a Hummer method. More particularly, graphite that was a precursor of the graphite oxide was mixed in a solution of sulfuric acid (H₂SO₄) and potassium permanganate (KMnO₄), and stirred at room temperature for at least 2 hours. Hydrogen peroxide was added to the mixed solution at a point of time when the mixed solution turned yellow during the stirring, and oxidation of graphite was performed. When the oxidation reaction was completed, the resulting reaction mixture was centrifuged, and then dried to obtain a graphite oxide in the form of powder.

### Example 1

Four parts by weight of the graphite oxide powder prepared in Preparative Example was added to 100 parts by weight of distilled water, and subjected to ultrasonic waves for 60 minutes. In this operation, a dispersion in which the graphite oxide powder was uniformly dispersed was prepared. A hydrochloride solution was added to the resulting dispersion so that pH was adjusted to 2.0. Twenty parts by weight of vitamin C which was a reducing agent was mixed with the dispersion having an adjusted pH of 2.0, and then stirred. Thereafter, the resulting mixture was thermally treated at 60° C. for 8 hours in an oven. In this operation, a three-dimensional gel was obtained. The resulting gel was lyophilized for 24 hours in a freeze dryer. The pressure of the freeze dryer was 10⁻¹ Pa, and the temperature was in a range of −60° C. to −50° C.

### Example 2

A graphene structure was prepared in the same manner as in Example 1, except that the pH of the dispersion in which the graphite oxide was dispersed was adjusted to 4.1.

### Example 3

A graphene structure was prepared in the same manner as in Example 1, except that the pH of the dispersion in which the graphite oxide was dispersed was adjusted to 4.5.

### Example 4

Four parts by weight of the graphite oxide powder prepared in Preparative Example was added to 100 parts by weight of distilled water, and subjected to ultrasonic waves for 60 minutes. In this operation, a dispersion in which the graphite oxide powder was uniformly dispersed was prepared. An acetic acid solution was added to the resulting dispersion so that pH was adjusted to 5.9. Twenty parts by weight of vitamin C which was a reducing agent was mixed with the dispersion having an adjusted pH of 5.9, and then stirred. Thereafter, the resulting mixture was thermally treated at 60° C. for 8 hours in an oven. In this operation, a three-dimensional gel was obtained. The resulting gel was lyophilized for 24 hours in a freeze dryer. The pressure of the freeze dryer was 10⁻¹ Pa, and the temperature was in a range of −60° C. to −50° C.

### Example 5

Four parts by weight of the graphite oxide powder prepared in Preparative Example was added to 100 parts by weight of distilled water, and subjected to ultrasonic waves for 60 minutes. In this operation, a dispersion in which the graphite oxide powder was uniformly dispersed was prepared. A sodium hydroxide solution was added to the resulting dispersion so that pH was adjusted to 9.7. Twenty parts by weight of vitamin C which was a reducing agent was mixed with the solution having an adjusted pH of 9.7, and then stirred. Thereafter, the stirred solution was thermally treated at 60° C. for 8 hours. In this operation, a three-dimensional gel was obtained. The resulting gel was lyophilized for 24 hours in a freeze dryer. The pressure of the freeze dryer was 10⁻¹ Pa, and the temperature was in a range of −60° C. to −50° C.

### Experimental Example 1

### Observation of Tissues of Graphene Structure

To determine changed in pore size and volume per unit mass of the graphene structures prepared in Examples 1 and 4, the tissues of the graphene structures were observed using a digital camera and a scanning electron microscope (SEM).

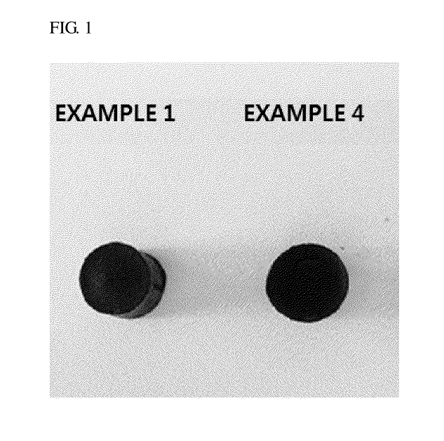

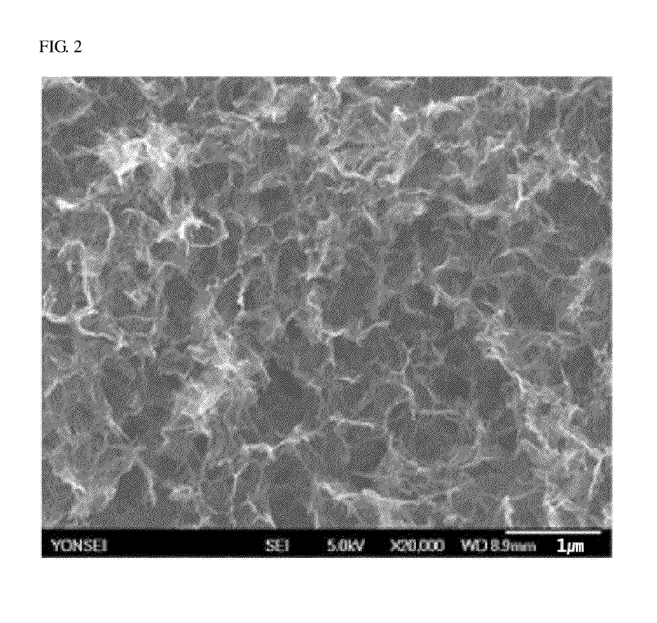

FIG. 1 is a digital camera image of the graphene structures prepared in Examples 1 and 4, and FIG. 2 is a scanning electron microscope image of the graphene structure prepared in Example 1.

### Experimental Example 2

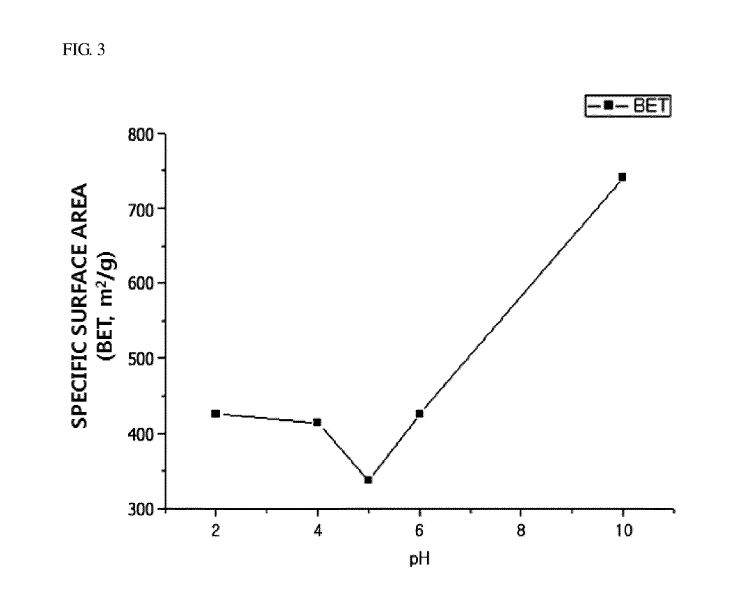

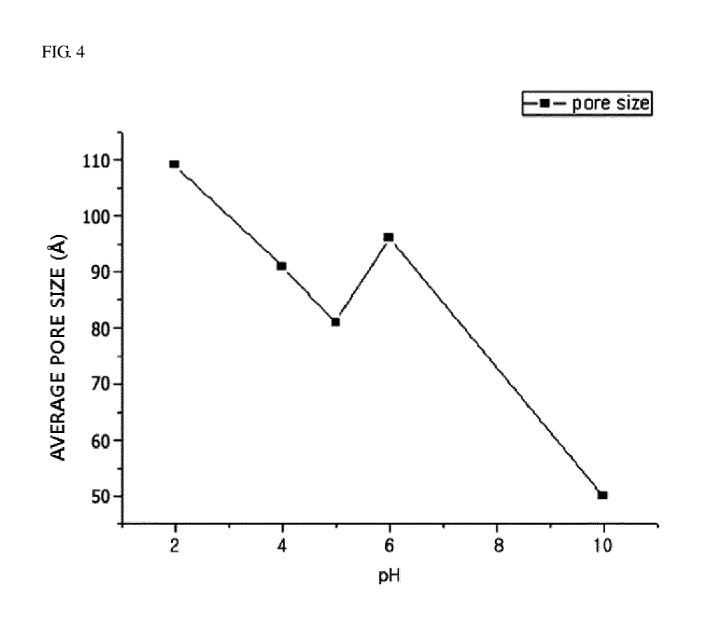

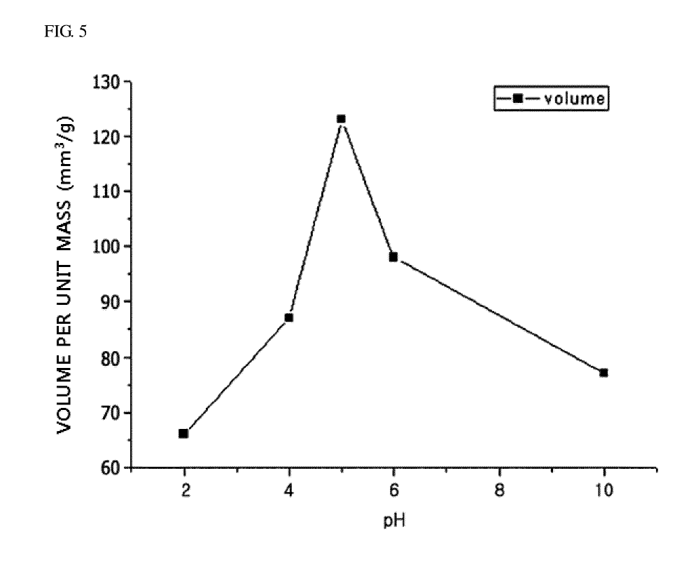

The three-dimensional graphene structures prepared in Examples 1 to 5 were measured for pore size and volume per unit mass. The pore size was measured using Micrometritics ASAP2010M+C equipment, and the volume per unit mass was measured using a physical measurement method. Also, each of the resulting graphene structures was measured for specific surface area. The measurement results are listed in the following Table 1. Also, the results obtained by measurement of the physical properties of each graphene structure are shown in FIGS. 3 to 6.

TABLE 1

| | Examples | | | | |
|---|---|---|---|---|---|
| | 1 | 2 | 3 | 4 | 5 |
| pH of dispersion | 2.0 | 4.1 | 4.9 | 5.9 | 9.7 |
| Specific surface area (m²/g) | 426 | 414 | 338 | 426 | 741 |
| Average pore size (Å) | 109 | 91 | 81 | 96 | 50 |
| Volume per unit mass (mm³/g) | 66 | 87 | 123 | 98 | 77 |
| C/O ratio of dispersion | 5.51 | 4.76 | 3.52 | 4.25 | 5.69 |

In terms of the specific surface area, it could be seen that the specific surface area of the resulting graphene structure gradually decreased as the pH value of the dispersion increased in pH 5 or less. It was confirmed that the specific surface area was suddenly reduced with an increase in pH at a point of time in which the pH value of the dispersion exceeded 5.

Referring to the average pore size of the graphene structure, it was confirmed that the pore size decreased as the pH value of the dispersion increased in pH 5 or less, and then increased at a point of time in which the pH value of the dispersion exceeded 5. Further, when the pH value of the dispersion was within a basic region, it could be seen that the pore size decreased with an increase in pH value of the dispersion.

In terms of the volume per unit mass of the graphene structure, it was also confirmed that the volume per unit mass suddenly increased as the pH value of the dispersion increased in pH 5 or less. It could be seen that the volume per unit mass rather decreased with an increase in pH at a point of time in which the pH value of the dispersion exceeded 5.

### INDUSTRIAL APPLICABILITY

The graphene according to the present invention can be used in electrodes for various devices, and, for example, used in energy storage devices, gas sensors, mirco-parts for biomedical engineering, or highly functional complexes.

What is claimed is:

1. A method of preparing a three-dimensional graphene structure, comprising:
preparing a dispersion in which a graphite oxide is dispersed; and
controlling a degree of reduction of the dispersion to preparing a gel.

2. The method of claim 1, wherein, in the controlling of the degree of reduction of the dispersion to prepare the gel, an average specific surface area of the graphene structure satisfies the following Equation 1:
[BET]=a₁×P+b₁ [Equation 1]
wherein [BET] represents a specific surface area (m²/g) of the resulting graphene structure, and P represents a pH of the dispersion, provided that:
(i) a₁ is an integer ranging from −40 to −25, and b₁ is an integer ranging from 400 to 600 when P is less than or equal to 5, and
(ii) a₁ is an integer ranging from 50 to 100, and b₁ is an integer ranging from −100 to 50 when P is greater than 5.

3. The method of claim 1, wherein, in the controlling of the degree of reduction of the dispersion to prepare the gel, an average pore size of the graphene structure satisfies the following Equation 2:
[Pore Size]=a₂×P+b₂ [Equation 2]
wherein [Pore Size] represents an average pore size (Å) of the resulting graphene structure, and P represents a pH of the dispersion, provided that:
(i) a₂ is an integer ranging from −15 to −5 and b₂ is an integer ranging from 120 to 140 when P is less than or equal to 5,
(ii) a₂ is an integer ranging from 7 to 18 and b₂ is an integer ranging from 0 to 20 when P is greater than 5 or less than or equal to 6, and
(iii) a₂ is an integer ranging from −20 to −15 and b₂ is an integer ranging from 140 to 180 when P is greater than 6.

4. The method of claim 1, wherein, in the controlling of the degree of reduction of the dispersion to prepare the gel, a volume per unit mass of the graphene structure satisfies the following Equation 3:
[Volume]=a₃×P+b₃ [Equation 3]
wherein [Volume] represents a volume per unit mass (mm³/g) of the resulting graphene structure, and P represents a pH of the dispersion, provided that:
(i) a₃ is an integer ranging from 15 to 25 and b₃ is an integer ranging from 0 to 40 when P is less than or equal to 5, and
(ii) a₃ is an integer ranging from −18 to −10 and b₃ is an integer ranging from 170 to 220 when P is greater than or equal to 5.

5. The method of claim 1, wherein, in the preparing of the dispersion in which the graphite oxide is dispersed, the dispersion includes the graphite oxide at 1 to 10 parts by weight, based on 100 parts by weight of a solvent.

6. The method of claim 1, wherein the controlling of the degree of reduction of the dispersion to prepare the gel comprises mixing a reducing agent at a content of 200 to 2,000 parts by weight, based on 100 parts by weight of the graphite oxide, to control the degree of reduction of the dispersion.

7. The method of claim 1, wherein the controlling of the degree of reduction of the dispersion to prepare the gel comprises subjecting the gel to a first heat treatment process after controlling the degree of reduction of the dispersion and before preparation of the gel.

8. The method of claim 7, wherein the first heat treatment process is performed at a temperature of 60° C. to 90° C. for 10 to 60 hours.

9. The method of claim 8, further comprising:
performing a second heat treatment process of drying the gel at a temperature of 70° C. to 95° C. for 2 to 5 hours after the first heat treatment process.

10. The method of claim 1, further comprising:
drying the gel after the controlling of the degree of reduction of the dispersion to prepare the gel.

11. The method of claim 10, wherein the drying of the gel is performed through lyophilization.

12. The method of claim 9, further comprising:
applying microwaves to the gel after the drying of the gel.

13. A three-dimensional graphene structure comprising pores having an average size of 40 to 150 Å, the graphene structure having a specific surface area of 300 to 800 m²/g.

14. The three-dimensional graphene structure of claim 13, wherein the graphene structure has a volume per unit mass of 50 to 150 mm³/g.
